(19) United States
(12) Patent Application Publication
(10) Pub. No.: US 2011/0141893 A1
(43) Pub. Date: Jun. 16, 2011

(54) APPARATUS FOR MANAGING NETWORK ON PER-SUBFLOW BASIS

(75) Inventor: Jongtae SONG, Daejeon (KR)

(73) Assignee: Electronics and Telecommunications Research Institute, Daejeon (KR)

(21) Appl. No.: 12/961,806

(22) Filed: Dec. 7, 2010

(30) Foreign Application Priority Data
Dec. 10, 2009 (KR) 10-2009-0122685
Jun. 11, 2010 (KR) 10-2010-0055501

(51) Int. Cl. H04L 12/26

(52) U.S. Cl. 370/235

(57) ABSTRACT

A subflow management apparatus that transmits media traffic to a user over a network includes a subflow transmitter and a subflow controller. The subflow transmitter identifies the characteristics of the media traffic, and classifies a flow contained in packets of the media traffic transmitted during the same session into at least one subflow and transmits the subflow to the user. The subflow controller collects information of the network required to transmit the media traffic to the user, and controls the subflow transmitter so that the media traffic is classified into the at least one subflow according to the information of the network.

### CROSS-REFERENCE TO RELATED APPLICATION

This application claims priority to and the benefit of Korean Patent Application Nos. 10-2009-0122685 and 10-2010-0055501 filed in the Korean Intellectual Property Office on Dec. 10, 2009 and Jun. 11, 2010, the entire contents of which are incorporated herein by reference.

### BACKGROUND OF THE INVENTION

(a) Field of the Invention

The present invention relates to an apparatus for managing a network on a per-subflow basis. More particularly, the present invention relates to an apparatus for managing a network by classifying media traffic into subflows.

(b) Description of the Related Art

With the recent increase in multimedia traffic, the importance of quality of service (hereinafter referred to as “QoS”), quality of experience (hereinafter referred to as “QoE”), and bandwidth is rising. QoS/QoE in networks have been achieved in a manner so as to control the bandwidth of traffic on a per-multimedia session basis and ensure a bandwidth to a degree that the multimedia session requires. A multimedia session in an IP-based network has been defined on an IP flow basis, and an IP flow has been defined as a combination of 5 tuples (source address, destination address, source port, destination port, and protocol) and a type of service (TOS) field used as a differentiated services code point, both of which are defined in the IP packet header and the L4 packet layer (TCP or UDP) header.

Meanwhile, there is increasing interest in the technology of effectively encoding high-capacity media traffic with the advent of high-definition multimedia. Accordingly, multimedia traffic is encoded in various ways, and information encoded for effective information delivery is classified and packetized according to its degree of importance. For example, in the case of scalable video coding (SVC), additional information required for standard-resolution images and high-definition images is encoded in different tiers from each other and transmitted. Also, as for information of a still picture at a particular point in time of a Moving Picture Experts Group (MPEG) file, a moving vector indicating the rate of change from a still picture on frame I is transmitted in frame B and frame P, separately. In the Internet base media service such as IPTV service, different types of media streams such as video, audio, text, and other meta-data are encoded together and transmitted over multiple sub-flows in a single session.

In this manner, the conventional technology of media transmission over a network is to control traffic on a per-flow basis. However, in order to actually transmit high-quality traffic, subflows have to exist in the same flow according to the characteristics of media, so it is difficult to control QoS/QoE by taking a flow into consideration based only on the header of a flow-based packet.

Accordingly, a technology for controlling a network on a per-subflow basis defined for each session irrespective of the characteristics of media traffic is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an apparatus for managing a network by classifying packets of media traffic into subflows depending on a network environment and a user's environment.

An exemplary embodiment of the present invention provides a subflow management apparatus that transmits media traffic to a user over a network, the apparatus including:

a subflow transmitter that identifies the characteristics of the media traffic, and classifies a flow contained in packets of the media traffic transmitted during the same session into at least one subflow and transmits the subflow to the user; and a subflow controller that collects information of the network required to transmit the media traffic to the user, and controls the subflow transmitter so that the media traffic is classified into the at least one subflow according to the information of the network.

Another exemplary embodiment of the present invention provides a subflow management apparatus that transmits media traffic to a user over a network, the apparatus including:

an ingress transport control that is located at a boundary point where the media traffic is transmitted to the network, and that identifies the characteristics of the media traffic and analyzes packets of the media traffic to determine the priority of the media traffic; an egress transport control that is located at a boundary point where the media traffic is transmitted to the user, and that classifies a flow of the packets transmitted by the ingress transport control into at least one subflow; and a subflow controller that collects information of the network required to transmit the media traffic to the user, and controls the ingress transport control and the egress transport control so that the media traffic is classified into the at least one subflow according to the information of the network, wherein the egress transport control receives media traffic directly transmitted without passing through the ingress transport control and classifies the media traffic into the at least one subflow.

Yet another exemplary embodiment of the present invention provides a subflow management apparatus that transmits media traffic to a user over a network, the apparatus including:

a subflow switch that transmits a result of segmentation of the media traffic depending on the network environment and the user's environment; and a subflow controller that collects information of the network and controls the subflow switch so that the media traffic is classified into predetermined flows according to the information of the network, wherein the subflow switch includes a multimedia content aware process engine that classifies the media traffic into the predetermined subflows according to the characteristics of an application layer, and generates grouped subflows using the predetermined subflows according to groups of users under similar conditions; and a subflow traffic control portion that transmits the grouped subflows to the user depending on the network environment and the user's environment.

### BRIEF DESCRIPTION OF THE DRAWINGS

FIG. 1 is a view showing a network to which a subflow management apparatus according to an exemplary embodiment of the present invention is applied.

FIG. 2 is a view showing one example in which a subflow transmitter of the subflow management apparatus shown in FIG. 1 segments packets of media traffic.

FIG. 3 is a view showing one example of a network to which the subflow transmitter of the subflow management apparatus shown in FIG. 1 is applied.

FIG. 4 is a view showing another example of a network to which the subflow transmitter of the subflow management apparatus shown in FIG. 1 is applied.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

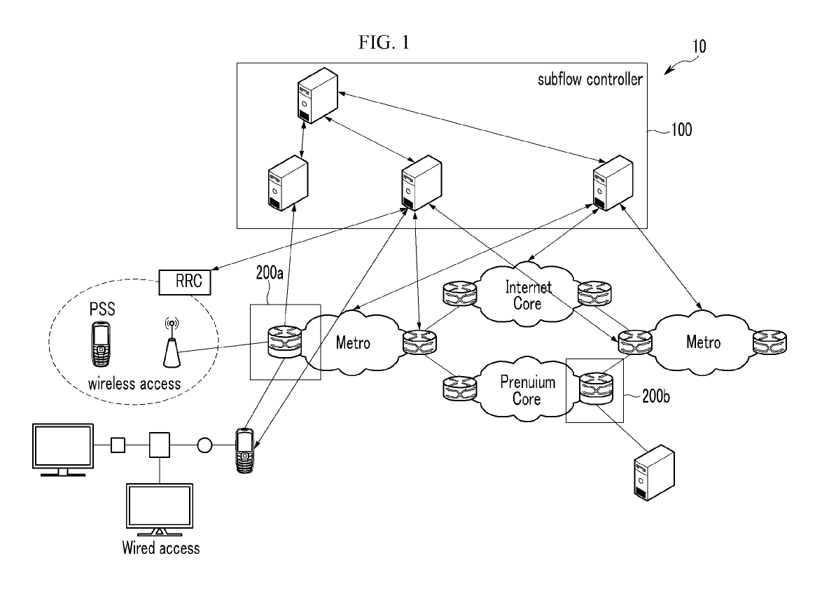

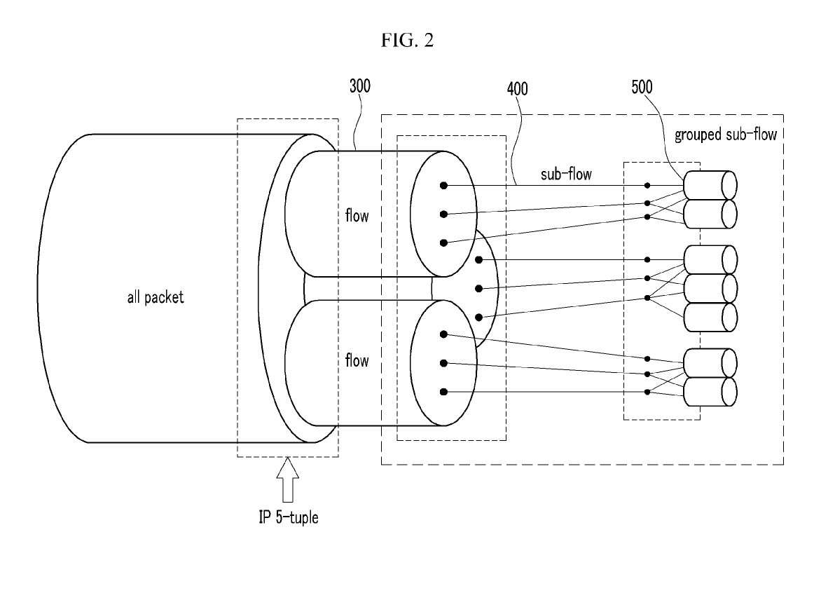

FIG. 1 is a view showing a network to which a subflow management apparatus according to an exemplary embodiment of the present invention is applied. FIG. 2 is a view showing one example in which a subflow transmitter of the subflow management apparatus shown in FIG. 1 segments packets of media traffic.

As shown in FIG. 1, the subflow management apparatus 10 for managing a network on a per-subflow basis according to an exemplary embodiment of the present invention controls the network by segmenting media traffic on the network in a manner so as to segment a media flow into subflows corresponding to the characteristics of the media. The subflow management apparatus 10 includes a subflow controller 100 and subflow transmitters 200a-200b. While the exemplary embodiment of the present invention has been illustrated with respect to two subflow transmitters, the present invention is not limited thereto and at least one subflow transmitter may be formed on the network.

The subflow controller 100 may include a plurality of servers, and performs an information collection function for collecting information of the network in order to effectively transmit media traffic and determine the state of the network. That is, the subflow controller 100 collects network performance information and network configuration information for each segment in order to perform the information collection function. Here, the network performance information indicates quality of service (hereinafter referred to as “QoS”) containing delay, loss, jitter, etc, which is used to determine the current situation of the network. The network configuration information indicates the configuration of each segment along the network path. Also, the subflow controller 100 performs an equipment control function for changing media traffic by controlling the subflow transmitters 200a-200b if required.

The subflow transmitters 200a-200b identify the characteristics of media traffic at boundary points of the network, classify a flow of packets transmitted during the same session into multiple subflows and segment the subflows according to the condition of the network, and combine the segmented subflows according to groups of users under similar conditions to generate grouped subflows and transmit them to the users. Here, the packets transmitted during the same session may consist of packets of various natures. For example, if media traffic, control traffic, and frame I and frames B and P of MPEG video media traffic are generated by scalable video coding (hereinafter referred to as “SVC”), the packets may include information of each layer and malicious traffic disguised as being transmitted in the same session as the media traffic.

For instance, in a state that media traffic of all packets are distinguished into flows 300 by the conventional 5 tuples, as shown in FIG. 2, the subflow transmitters 200a-200b segment each of the flows 300 into subflows 400 in a manner so as to segment each flow into data of different natures according to the characteristics of an application layer within the same flow. Here, the 5 tuples include source address, destination address, source port, destination port, and protocol. Also, the subflow transmitters 200a-200b combine the subflows 400 according to groups of users under similar conditions to generate grouped subflows 500 composed of required information and transmit them to the users. Mapping the subflows 400 into grouped subflows 500 according to the exemplary embodiment of the present invention is done based on the network provider policy, and the users receive the grouped subflows 500 optimized for the characteristics of their terminals and the status of the network.

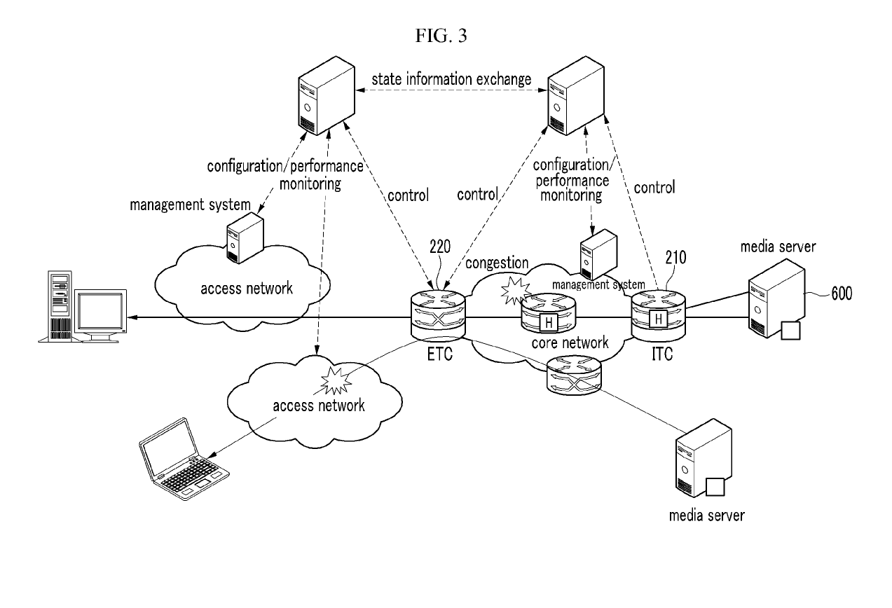

Hereinafter, the subflow transmitter according to the exemplary embodiment of the present invention will be described in detail with reference to FIG. 3.

FIG. 3 is a view showing one example of a network to which the subflow transmitter of the subflow management apparatus shown in FIG. 1 is applied.

As shown in FIG. 3, each of the subflow transmitters 200a-200b according to the exemplary embodiment of the present invention may be formed as an ingress transport control 210 (hereinafter referred to as “ITC”) or an egress transport control 220 (hereinafter referred to as “ETC”) that are respectively located at boundary points of the network.

The ITC 210 is located at a boundary point where media traffic enters the network through a media server 600. The ITC 210 analyzes packet contents of the media traffic transmitted over the same media, and distinguishes the media traffic according to priority and transmits it to the network. At this point, classification of the priority of subflows in a flow is shown, as an example, in Table 1, and may be changed according to the network provider policy. Although the exemplary embodiment of the present invention is configured in such a way that the priority of the media traffic is higher than the priority of control traffic as shown in Table 1, the priority of the media traffic and the priority of the control traffic may be altered according to the network provider policy and the priorities may be extended in several stages. At this point, priority may be classified using a differentiated services code point (DSCP) field of the IP header or using other fields, and indicates a dropping priority. That is, in a network delivery process, if detected congestion is above a specified level, packets with low dropping priority are dropped first.

TABLE 1

| | High priority | Low priority |
|---|---|---|
| Media traffic and control traffic | Media traffic | Control traffic |
| transmitted during the same | | |
| session | | |
| Frame I and frames B and P of | Frame I | Frame B, frame P |
| MPEG video media traffic | | |
| Information of each layer in | Base band | Higher resolution |
| case media traffic is generated | information | information |
| by SVC | | |
| Malicious traffic disguised as | Media traffic | Traffic identified as |
| being transmitted in the same | | malicious |
| session as media traffic | | |

The ETC 220 is located at a boundary point where media traffic is transmitted to access networks where the users are connected after passing through the core. The ETC 220 controls traffic while in the process of outputting the media traffic to the access networks from the core network, and classifies the media traffic into subflows according to the status of the access networks and transmits them to the users. The ETC 220 processes both the traffic transmitted via the ITC 210 and the traffic directly transmitted without passing through the ITC 210. That is, if traffic is transmitted via the ITC 210, the ETC 220 selectively drops the packets according to the priority specified in the ITC 210. If the traffic is directly transmitted without passing through the ITC 210, the ETC 220 analyzes contents of the traffic and distinguishes the traffic into subflows, and, if required, drops the packets from each subflow.

Moreover, the ETC 220 performs multicasting on a per-subflow basis. For example, the ETC 220 is located at a boundary node shared with wired/wireless access, and, in the case of transmitting media traffic to all access networks in a multicast fashion, transmits the media traffic differently according to the status of each access zone. That is, the ETC 220 transmits high-priority subflows to users within a wireless zone lacking in resources in order to service the users within a minimum bandwidth, and transmits all the subflows to wired access users who are rich in resources.

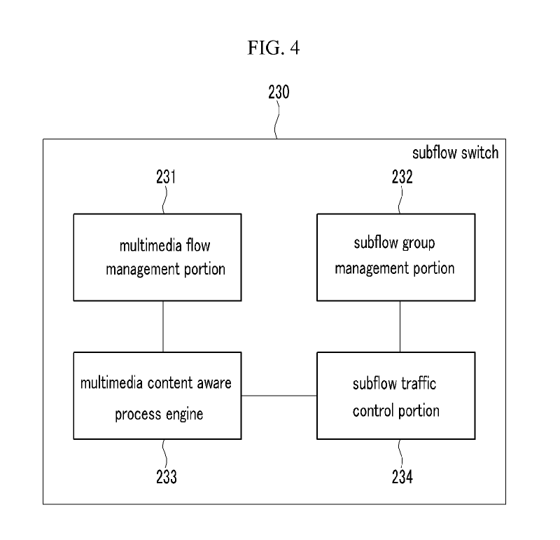

As noted above, the subflows transmitters 200a-200b may be formed as the ITC 210 or the ETC 220 and implemented in a router, or may be implemented as a subflow switch. A subflow transmitter formed as the subflow switch will be described in detail below with reference to FIG. 4.

FIG. 4 is a view showing another example of a network to which the subflow transmitter of the subflow management apparatus shown in FIG. 1 is applied.

As shown in FIG. 4, the subflow transmitters 200a and 200b according to the exemplary embodiment of the present invention may be formed as a subflow switch 230, and the subflow switch 230 receives traffic for a given session and distinguishes it into subflows and then transmits the subflows in a unicast or multicast fashion depending on the current network condition.

The subflow switch 230 includes a multimedia flow management portion 231, a subflow group management portion 232, a multimedia content aware process engine 233, and a subflow traffic control portion 234.

The multimedia flow management portion 231 keeps information of the session of media transmitted through the subflow switch 230, and manages priority according to the current state of the media traffic. The multimedia flow management portion 231 receives a state change request signal from a multimedia policy management system (not shown), and forwards the received state change request signal to the multimedia content aware process engine 233 so as to apply it to the subflows. That is, when a multimedia policy manager determines that the state of a certain flow needs to be changed, the multimedia flow management portion 231 receives the state change request signal from the multimedia policy management system (not shown) and forwards it to the multimedia content aware process engine 233.

The subflow group management portion 232 serves to multicast media traffic on a per-subflow basis. In the case that the subflow group management portion 232 performs multicasting on media traffic divided into multiple subflows, it limits the receivable bandwidth of a user according to the performance of the user terminal and the network environment. In this case, users who can receive media having a similar bandwidth are managed in one group for multicasting. For example, in the case of processing SVC traffic of different resolutions depending on the performance of a terminal, the subflow group management portion 232 transmits media traffic of a resolution suitable for the environment of a group of terminals having the same performance.

The multimedia content aware process engine 233 segments incoming media traffic defined for the same flow into subflows according to the characteristics of an application layer, and combines the segmented subflows to generate grouped subflows. At this point, the multimedia content process engine 233 receives an application profile that is capable of recognizing an application layer and the policies of the network from the multimedia flow management portion 231 in order to identify the characteristics of the application layer.

The subflow traffic control portion 234 receives the grouped subflows from the multimedia content aware process engine 233, and transmits the grouped subflows to the user depending on the network condition and the user's environment. That is, the subflow traffic control portion 234 transmits the grouped subflows to the user by executing functions such as scheduling, marking, and shaping depending on the network environment and the user's environment.

As such, the subflow management apparatus 10 according to the exemplary embodiment of the present invention can improve quality of service and quality of experience of a user in a network by segmenting media flows into subflows according to the characteristics of the media on the network and transmitting them depending on the network condition and the user's environment.

According to an exemplary embodiment of the present invention, quality of service and quality of experience of a user in a network can be improved by segmenting packets of a media flow into subflows according to the characteristics of the media on the network and transmitting them depending on the network condition and the user environment.

The above-described exemplary embodiment can be realized through a program for realizing functions corresponding to the configuration of the exemplary embodiment of the present invention or a recording medium for recording the program in addition to through the above-described device and/or method.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A subflow management apparatus that transmits media traffic to a user over a network, the apparatus comprising:
a subflow transmitter that identifies characteristics of the media traffic, and classifies a flow contained in packets of the media traffic transmitted during the same session into at least one subflow and transmits the subflow to the user; and
a subflow controller that collects information of the network required to transmit the media traffic to the user, and controls the subflow transmitter so that the media traffic is classified into the at least one subflow according to the information of the network.

2. The apparatus of claim 1, wherein the subflow transmitter generates grouped subflows using the at least one subflow according to groups of users under similar conditions, and transmits the grouped subflows to the user depending on the network environment and the user's environment.

3. The apparatus of claim 2, wherein the subflow transmitter is formed as an ingress transport control located at a boundary point where the media traffic is transmitted to the network, or an egress transport control located at a boundary point where the media traffic is transmitted to the user.

4. The apparatus of claim 3, wherein, if the subflow transmitter is an ingress transport control, the ingress transport control analyzes packets of the traffic to determine the priority of the media traffic.

5. The apparatus of claim 4, wherein, if detected network congestion is above a reference level, the ingress transport control drops packets of the media traffic with low priority first.

6. The apparatus of claim 3, wherein if the subflow transmitter is an egress transport control, the egress transport control receives each media traffic directly transmitted without passing through the ingress transport control, and classifies the media traffic into at least one subflow.

7. The apparatus of claim 6, wherein, if the media traffic is transmitted by the ingress transport control, the ingress transport control drops packets of the media traffic according to the priority determined by the ingress transport control.

8. The apparatus of claim 6, wherein, if the media traffic is transmitted not by the ingress transport control but is transmitted directly, the egress transport control analyzes a flow contained in packets of the media traffic and distinguishes the flow into at least one subflow, and, if required, drops the packets for each flow.

9. The apparatus of claim 3, wherein the subflow transmitter is formed as a subflow switch for executing the functions of the ingress transport control and the egress transport control.

10. The apparatus of claim 9, wherein the subflow switch comprises:
a multimedia flow management portion that keeps information of the session of the media traffic and determines priority according to the current state of the media traffic;
a subflow group management portion that, in the case of performing multicasting using the grouped subflows, controls the receivable bandwidth of a user according to the network environment and the user's environment;
a multimedia content aware process engine that classifies the media traffic into at least one subflow according to the characteristics of an application layer, and generates grouped subflows using the at least one subflow; and
a subflow traffic control portion that transmits the grouped subflows to the user depending on the network environment and the user's environment.

11. A subflow management apparatus that transmits media traffic to a user over a network, the apparatus comprising:
an ingress transport control that is located at a boundary point where the media traffic is transmitted to the network, identifies the characteristics of the media traffic, and analyzes packets of the media traffic to determine the priority of the media traffic;
an egress transport control that is located at a boundary point where the media traffic is transmitted to the user, and classifies a flow of the packets transmitted by the ingress transport control into at least one subflow; and
a subflow controller that collects information of the network required to transmit the media traffic to the user, and controls the ingress transport control and the egress transport control so that the media traffic is classified into the at least one subflow according to the information of the network,
wherein the egress transport control receives media traffic directly transmitted without passing through the ingress transport control and classifies the media traffic into the at least one subflow.

12. The apparatus of claim 11, wherein the egress transport control generates grouped subflows using the at least one subflow according to groups of users under similar conditions, and performs multicasting by transmitting the grouped subflows to the user depending on the network environment and the user's environment.

13. The apparatus of claim 11, wherein the information of the network comprises network performance information and network configuration information.

14. The apparatus of claim 13, wherein the network performance information indicates quality of service containing at least one of delay, loss, and jitter, and
the network configuration information indicates the configuration of each segment along the network path.

15. A subflow management apparatus that transmits media traffic to a user over a network, the apparatus comprising:
a subflow switch that transmits a result of segmentation of the media traffic depending on the network environment and the user's environment; and
a subflow controller that collects information of the network and controls the subflow switch so that the media traffic is classified into predetermined flows according to the information of the network,
wherein the subflow switch comprises:
a multimedia content aware process engine that classifies the media traffic into the predetermined subflows according to the characteristics of an application layer, and generates grouped subflows using the predetermined subflows according to groups of users under similar conditions; and
a subflow traffic control portion that transmits the grouped subflows to the user depending on the network environment and the user's environment.

16. The apparatus of claim 15, wherein the subflow switch comprises:
a multimedia flow management portion that keeps information of the session of the media traffic and determines priority according to the current state of the media traffic; and
a subflow group management portion that, in the case of performing multicasting using the grouped subflows, controls the receivable bandwidth of a user according to the network environment and the user's environment.

17. The apparatus of claim 16, wherein the multimedia content aware process engine receives an application profile for recognizing an application layer and the policies of the network from the multimedia flow management portion in order to identify the characteristics of the application layer.

18. The apparatus of claim 15, wherein the subflow traffic control portion transmits the grouped subflows to the user by executing functions such as scheduling, marking, and shaping depending on the network environment and the user's environment.
